(19) United States
(12) Patent Application Publication
(10) Pub. No.: US 2025/0378187 A1
(43) Pub. Date: Dec. 11, 2025

(54) DISCOVERY AND PROTECTION OF UNKNOWN DEVICES

(71) Applicant: Varonis Systems, Inc., New York, NY (US)

(72) Inventors: John NEYSTADT, Kfar Saba (IL); Lior CHEN, Herzliya (IL); Ron SNEH, Haifa (IL)

(21) Appl. No.: 18/739,239

(22) Filed: Jun. 10, 2024

(51) Int. Cl. G06F 21/62; G06F 21/56

(52) U.S. Cl. CPC G06F 21/6218; G06F 21/56

(57) ABSTRACT

Disclosed is a system and method for discovering and security unknown devices in a computer network. Audit logs of hardware devices (e.g., servers and edge devices) within the computer network are mined for discovery of other unknown connecting devices that are not currently in a monitoring database associated with a security monitoring system. For each detected unknown device, the system determines a type of the unknown device, adds the unknown device to the monitoring database, and performs a data protection action selected for the type of the unknown device.

### TECHNICAL FIELD

The present disclosure relates to the field of network security and asset management, and more specifically, to systems and methods for discovering networked assets for implementation of IT security measures.

### BACKGROUND

Modern organizations rely extensively on computer networks to facilitate communication, collaboration, and data exchange. However, the complexity and scale of these networks present significant challenges in maintaining visibility and control over the multitude of assets that connect to them.

Conventional methods of asset discovery and inventory management often involve manual processes and rely on traditional network scanning techniques. For example, manual scans, spreadsheets, and disparate inventory databases, while useful, are limited in their effectiveness, often resulting in incomplete or inaccurate inventories, and are inefficient, time-consuming, and prone to errors, especially in dynamic and rapidly changing network environments. Moreover, organization databases used for asset management are frequently incomplete, fractured, or decentralized between different departments within the organization.

The proliferation of mobile devices, Internet of Things (IoT) devices, and cloud-based services has exacerbated the challenge of asset discovery and inventory management. These devices often connect to the network without IT's knowledge or approval, creating blind spots that can be exploited by attackers to gain unauthorized access or compromise network security. As a result, organizations struggle to maintain an accurate and up-to-date inventory of assets connected to their computer networks. The fragmented nature of organization databases, combined with manual processes and conventional network scanning techniques, further exacerbates the problem, hindering effective network management, security risk mitigation, and compliance enforcement.

### SUMMARY

According to various aspects, the subject technology addresses the limitations of existing approaches to asset discovery and IT security measures by providing a system and method for automated discovery and management of unknown devices and assets across an enterprise computer network. The disclosed system solves the foregoing problems by coalescing audit logs from various services (e.g., firewall, file servers, etc.) that indicate access attempts to connect within or through the enterprise network, and comparing devices within those audit logs against currently monitored devices to identify devices that should be monitored. After the devices are identified, the necessary security action can be performed (e.g., manually or automatically).

In particular, a method according to subject technology comprises storing, in a monitoring database associated with a security monitoring system, a list of known entities for which a security monitoring system is monitoring via a computer network; automatically obtaining, from one or more audit databases, one or more audit logs indicating entities within the computer network that have initiated access with one or more computing systems that are internal or external to the computer network; automatically determining, from the one or more audit logs, one or more unknown entities that are not in the known entities stored in the monitoring database; and for each determined unknown entity: automatically determining a type of the unknown entity; automatically adding the unknown entity to the monitoring database; automatically selecting a data protection action based on the type of the unknown entity; and automatically facilitating security of network communications pertaining to the unknown entity and the computer network by performing the data protection action. Other aspects include corresponding systems, apparatus, and computer program products for implementation of the corresponding method and its features.

By automating device discovery and inventory management, the subject technology enables organizations to maintain real-time visibility into their network assets, identify unauthorized or rogue devices, and enforce security policies through protection actions, consistently across the entire network infrastructure. Additionally, the subject technology centralizes and consolidates asset information, overcoming the challenges posed by incomplete, fractured, or decentralized organization databases.

Overall, the subject technology represents a significant advancement in the field of network security by providing an efficient and effective solution for discovering and inventorying unknown devices and assets in computer networks. By automating this critical aspect of network management and addressing the shortcomings of conventional approaches, the subject technology empowers organizations to better protect their IT infrastructure, mitigate security risks, and ensure compliance with regulatory requirements. Moreover, the disclosed system may be augmented with advanced network scanning techniques, machine learning algorithms, and data analytics to continuously monitor and identify all devices connecting to the network.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

For a better understanding of the various described implementations, reference should be made to the Description of Implementations below, in conjunction with the following drawings. Like reference numerals refer to corresponding parts throughout the figures and description.

FIG. 1 depicts a block diagram of an example system for automated discovery and protection of unknown devices and assets across an enterprise computer network, according to aspects of the subject technology.

FIG. 2 depicts a sequence diagram of an example process for automated discovery and protection of unknown user endpoint devices across an enterprise computer network, according to aspects of the subject technology.

FIG. 3 depicts an example process flow diagram for automated discovery and protection of unknown devices and assets across an enterprise computer network, according to aspects of the subject technology.

FIG. 4 is a conceptual diagram illustrating an example electronic system for automated discovery and protection of unknown devices and assets across an enterprise computer network, according to aspects of the subject technology.

### DESCRIPTION

Reference will now be made to implementations, examples of which are illustrated in the accompanying drawings. In the following description, numerous specific details are set forth in order to provide an understanding of the various described implementations. However, it will be apparent to one of ordinary skill in the art that the various described implementations may be practiced without these specific details. In other instances, well-known methods, procedures, components, circuits, and networks have not been described in detail so as not to unnecessarily obscure aspects of the implementations.

Modern organizations face the problem of how to automatically discover devices and entities that should be monitored within a large-scale enterprise network. The solution described herein involves coalescing audit logs from various services (e.g., firewall, file servers, etc.) that indicate access attempts to connect within or through the enterprise network, and comparing devices within those audit logs to a list of currently monitored devices to identify devices that are not monitored but should be. After the devices are identified, protection actions can be performed (e.g., manually or automatically) with regard to the newly discovered device(s). Accordingly, unknown devices and assets can be automatically and efficiently discovered and managed across an enterprise network.

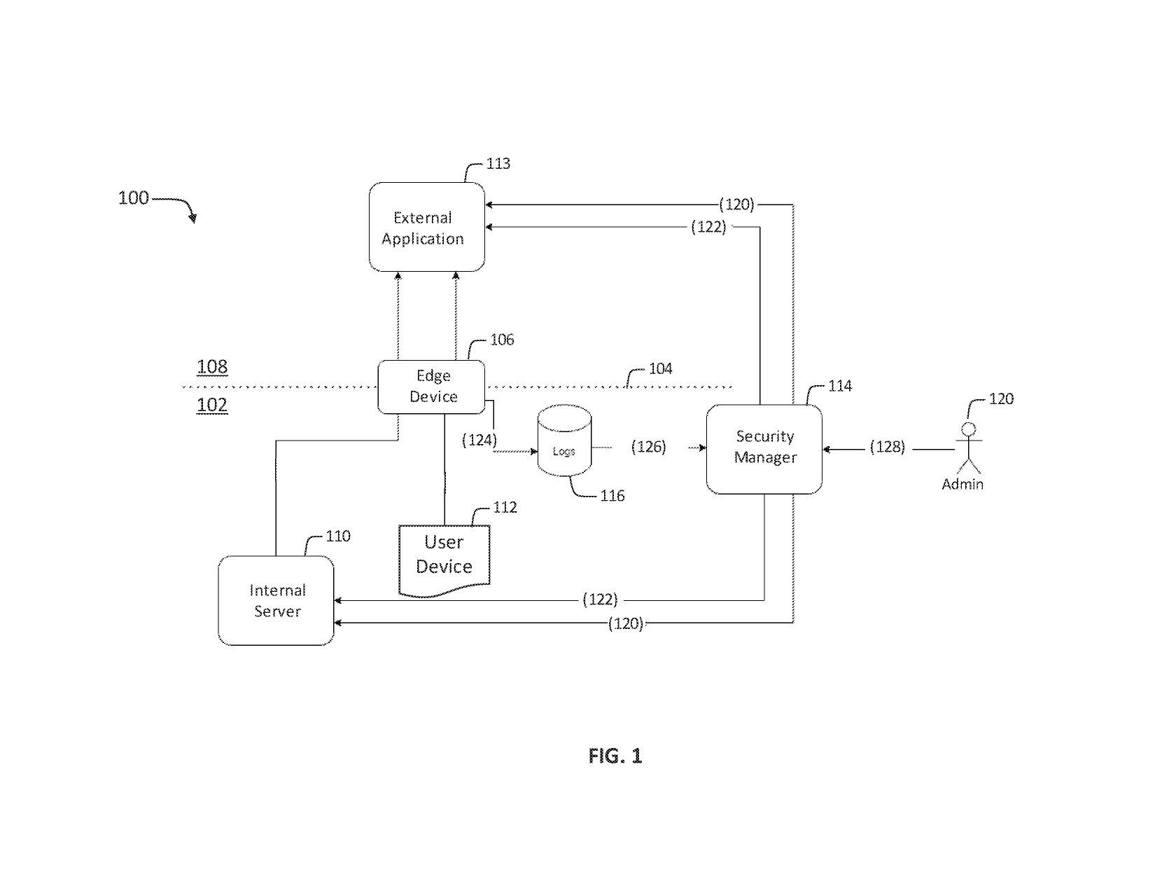

FIG. 1 depicts a block diagram of an example system 100 for automated discovery and management of unknown devices and assets across an enterprise computer network, according to aspects of the subject technology. In an enterprise computing network, various assets play crucial roles in facilitating operations and maintaining network integrity. These assets encompass hardware components, software systems, and networking infrastructure tailored to meet organizational requirements.

An enterprise network 102 according to aspects of the subject technology is structured with several hardware components to ensure efficient operations and robust security measures. At the perimeter 104 of the network 102 are edge devices 106, such as routers, firewalls, proxy servers, and intrusion detection/prevention systems (IDPS) that may be deployed to control traffic flow between the organization assets within enterprise network 102 and devices and/or systems of external networks 108, and to protect against unauthorized access and malicious attacks from external networks 108.

Within the internal organizational network 102, various segments or zones may be established (not shown), separated by internal edge devices 106 such as firewalls or routers, and/or access control lists. These segments may correspond to different departments within the organization, for example, between human resources, accounting, and/or research and development departments. By segmenting the network, access to sensitive resources can be restricted, and traffic can be closely monitored to prevent unauthorized access or data breaches.

Internal servers 110, such as file servers, may store and manage shared files and data within the organization. These servers may be restricted to respective departments or shared across departments. Access to these servers may be generally controlled through permissions and authentication mechanisms to ensure that only authorized users can access and modify the data. Similarly, the internal servers 110 may include application servers hosting business-critical applications such as email servers, database servers, and web servers. Such servers may also be protected with encryption, access controls, and regular security updates. In large organizations, ad-hoc connection of such servers to the network by departmental actors within the organization pose a security problem in that permissions and authentication requirements may not correspond with those implemented by the organization at large.

User devices 112, including desktop computers, laptops, tablets, and smartphones and other mobile devices, may also be connected to the network either wired or wirelessly. These devices, which may connect ad-hoc and without notice, access resources on the network 102 and may store sensitive data locally. Thus, endpoint security solutions such as antivirus software, endpoint detection and response (EDR) systems, and mobile device management (MDM) solutions may be deployed on such devices 112 to protect the devices—and other organizational assets on the network that connect to these devices (such as servers 110)—from malware and other security threats. However, such user endpoint devices 112 may be connected momentarily and/or to network endpoints, or to outside application servers 113, that are incapable of enforcing a threshold level of security protection with regard to these devices, thus creating difficulty for the organization to understand what assets are adequately protected within its network.

According to various implementations, one or more security management server systems 114 are implemented to enforce data security policies and compliance across an organization’s network. Such system include one or more security manager server(s) 114. These servers may further include or be part of, for example, a data loss prevention (DLP) solution, encryption enforcement technologies, and/or user activity monitoring tools. Such systems may prevent unauthorized access to sensitive data on the network 102, monitor data usage and movement, and generate alerts or reports on policy violations. Additionally, with the rise of remote work, an organization may provide secure remote access to the internal network 102 and its resources using virtual private networks (VPNs), multi-factor authentication (MFA), and secure remote desktop solutions, ensuring that remote users can securely connect to the network via externally connected devices 112 while maintaining data confidentiality and integrity.

In some implementations, the security manager server(s) 114 may include a data security posture manager (DSPM) or DSPM functionality. A DSPM may employ monitoring or probing of various devices within the internal network 102 or outside via external network 108. For example, the DSPM may probe (120) devices within and outside the network 102 by way of vulnerability scanning, penetration testing, and other security assessments to identify weaknesses, misconfigurations, or vulnerabilities that could be exploited by attackers. Additionally or in the alternative, the DSPM may monitor (122) such devices via deployment of lightweight agents on endpoints or servers to continuously collect data on configurations, software versions, patch levels, and user activities. By analyzing such information, the DSPM may assess the security status of each device and identifies any deviations from the organization's security policies. The DSPM may further passively monitor network traffic to and from individual devices, analyzing network traffic patterns and communication behaviors to identify potential security incidents or policy violations.

Overall, the enterprise network layout is designed to provide secure and efficient access to resources while safeguarding sensitive data from unauthorized access and cyber threats. Regular security assessments, audits, and updates may be performed, for example, by the security manager server(s) 114, to maintain the effectiveness of the network security infrastructure and adapt to evolving security threats and regulatory requirements. However, such security protection mechanisms often depend on knowledge of the devices that should be monitored. More than often, monitoring databases are incomplete, fractured, or decentralized between departments.

Each internal entity (e.g., file or web server 110, edge device 106, and the like) within the internal network 102 may generate detailed records of activities and events related to connections and communications between the entity and other devices on the network. These audit logs may include information such as connection details pertaining to devices requesting access to or utilizing services of the internal entities. Such audit logs may include structured fields that, for example, store a name or other identifier of a connecting device, source and destination IP addresses, port numbers, and protocols, access control decisions, security threats detected, administrative actions taken, policy violations, authentication events, system events, and/or traffic statistics.

The security manager server(s) 114 (including, e.g., the DSPM) may collect and analyze logs generated by individual devices on the network 102, including system logs, application logs, and security logs (any of which, or collectively, may be referred to as an audit log herein), to monitor for suspicious activities, security events, and compliance violations. In some implementations, the security manager server(s) 114 may pull the audit logs directly from the edge devices 106 and servers 110. In some implementations, the edge devices 106 and servers 110 (and properly configured user devices 102) within the internal network 102 may be configured to periodically upload or otherwise transmit (124) these and/or other logs to a centralized database 116. The database 116 may include, for example, a central audit event repository, such as a SIEM (Security Information and Event Management) system. In some implementations, a security manager server(s) 114 may pull this information from known devices and store the information in database 116. The security manager server(s) 114 may then query the database 116 to obtain (126) the audit logs or to extract certain records from the logs.

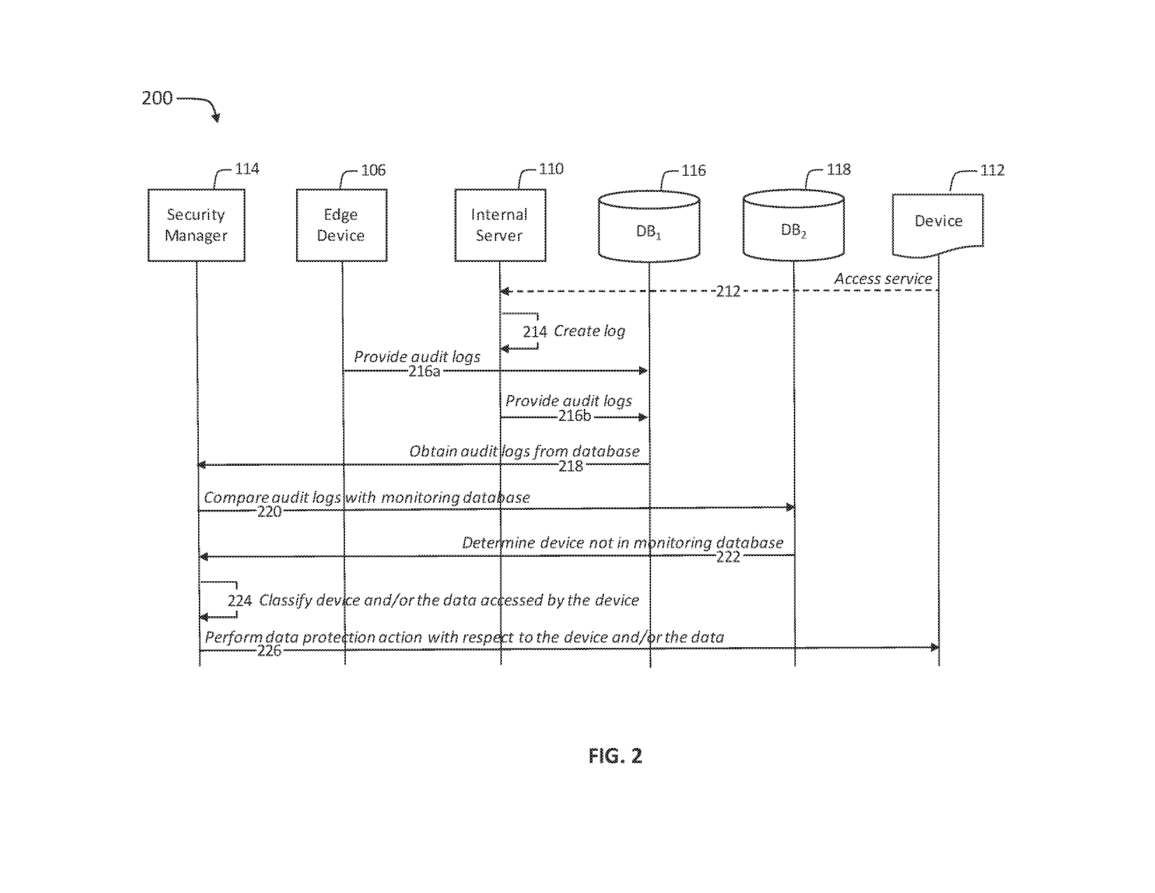

According to various aspects of the subject technology, the security manager server(s) 114 may maintain a monitoring list of known entities (e.g., edge devices 106, servers 110, devices 112, and/or applications on such devices) for which the security manager server(s) 114 is configured to periodically assess for suspicious activities, security events, and compliance violations. In this regard, the security manager server(s) 114 monitors network activity and/or the configuration profiles of the devices on the monitoring list to identify potential security incidents or policy violations on individual devices. The monitoring list may be stored as a separate record set in database 116 or may be stored in an entirely separate database (e.g., in database 118 of FIG. 2).

Accordingly, as will be described further herein, the security manager server(s) 114 may obtain (e.g., from database 116) the audit logs indicating entities within the computer network 102 that have requested access to one or more data elements that are internal or external to the computer network, and determine, from the audit logs, one or more unknown entities that are not in the monitoring database. In this regard, the security manager server(s) 114 may detect user devices 112 and/or internal servers 110 that are connecting to an unknown software application 113 in an external network 108 by analysis of the audit logs of an edge device 106. The unknown entities (including internal devices 106, 110, 112 or external devices 113) may then be placed on the monitoring list for further monitoring, information collection, and implementation of data protection actions.

In some implementations, the unknown entities may first be provided to an administrator 120 (e.g., or designated user) who may choose to manage approval (128) of the entities for monitoring before the entities are placed on the monitoring list. If the administrator 120 (or designated user) is not interested, the entities may be flagged or otherwise be placed on an ignore list so that if observed again (e.g., in another audit log) the entity will not be resurfaced.

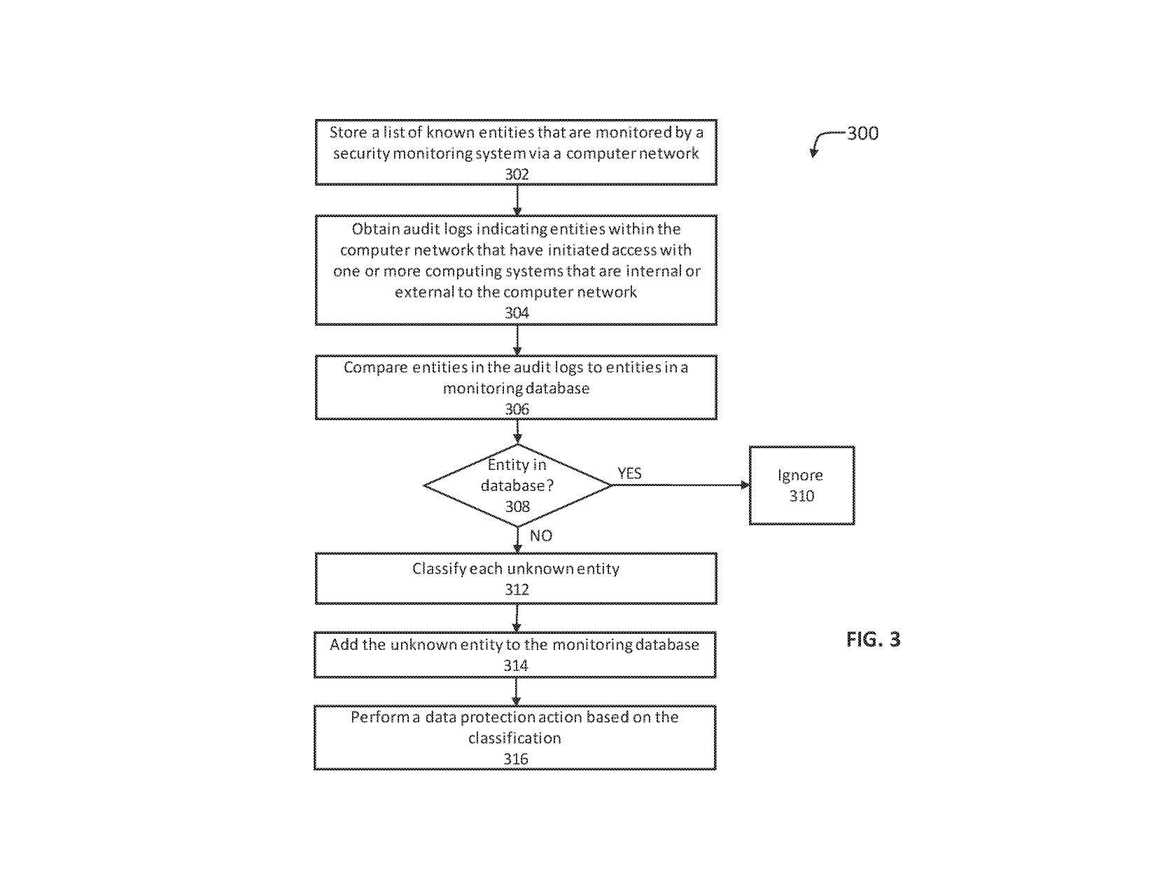

FIG. 2 depicts a sequence diagram of an example process 200 for automated discovery and protection of unknown user endpoint devices across an enterprise computer network, according to aspects of the subject technology. Detection and protection of server devices may be performed similarly, and described with regard to FIG. 3.

As described previously, an enterprise network 102 may include one or more edge devices 106, one or more servers 110, a security manager server(s) 114, and one or more databases 116. The depicted example of FIG. 2 is described with regard to an unknow user endpoint device. It is understood, however, that that process described may also be applicable to an unknown server 110 or an unknown edge device 106 connecting to another device on the network 102 in the same or similar manner.

As shown in FIG. 2, an unknown endpoint computing device 112 (e.g., a user mobile device) may connect ad-hoc to known enterprise computing elements such as a server 110 or edge device 106 from within the enterprise network 102, or from an external network 108, for example, through an approved (or unapproved) network channel (e.g., using a VPN, exposed port, open address, guest network, etc.). In the depicted example, the computing device 112 accesses an internal server 110 (212). In response to the connection, the internal server 110 creates a record of the access in an audit log, including information describing the connecting device (e.g., name or other identifier, address, events, etc.) and, in some implementations, activities performed or requested by the device while connected (214).

The various audit logs generated by the edge device(s) 106 and server(s) 110 are periodically provided by the various systems to a centralized database 116 (216 a, 216 b). In this regard, the audit logs may be extracted from the devices and uploaded to the database 116 by a different server within the organization (e.g., security manager server(s) 114), or may be directly provided by the devices themselves.

The security manager server(s) 114 obtains the audit logs from the database 116 (218) and compares the entities identified in the audit logs to entities in its own monitoring database 118 (220). In this regard, the security manager server(s) 114 can determine, from the audit logs, one or more unknown entities (e.g., devices or applications) recorded in the logs that are not in the monitoring database 118. In the depicted example, the security manager server(s) 114 identifies device 112 as having been recorded in the audit log generated by server 110 but not currently recorded in the monitoring database 118 (222).

In some implementations, the security manager server(s) 114 identifies entities by way of extracting identifying information from one or more structured fields of each audit log, and then checking the identifier against its own monitored resource list in database 118 to determine whether the entity is already being monitored by the security manager server(s) 114 or another monitoring system of the organization. In some implementations, the security manager server(s) 114 may extract a list of entities and then compare the list to the monitoring list. In some implementations, particularly for audit logs wherein the data is unstructured or of an unknown format, the security manager server(s) 114 may utilize a form of log summarization using large language model (LLM) processing, or conventional regular expression extraction to obtain the identifier(s).

Once identified, the security manager server(s) 114 classifies or otherwise determines the type of the device (224), in order to determine what follow up security related actions should be performed with regard to the device. In the depicted example, the device 112 is determined to be a user endpoint device; that is, a computing device such as a laptop or other mobile device that connected to the network ad-hoc. In other examples, the device 112 may be classified as a server that was newly connected to the network.

After the device 112 is classified, the security manager server(s) 114 proceeds to perform a data protection action with regard to the device (226). The data protection action employed may be determined based on the classification/type of the device 112. For example, where the device 112 is a user endpoint device, the security manager server(s) 114 may attempt to install anti-virus software on the device 112. Additionally or in the alternative, the security manager server(s) 114 may implement further monitoring of the device 112 via endpoint detection and response (EDR) to collect and analyze data, including system activities, file changes, network connections, and process executions, to identify potential security incidents; or may attempt to configure device settings or enforce security policies on the device by way of a deployment of applications and updates to the device via a mobile device management solution.

Further monitoring actions—also applicable to newly discovered servers—may include the security manager server(s) 114 sending probes (122 of FIG. 1) to auto discover data source entity type and vendor, based active network or other methods data source probing. For example, the security manager server(s) 114 may send HTTP or RPC requests to known ports, perform TCP fingerprinting to detect characteristics of a TCP/IP stack implementation or to examine a combination of TCP flags, or perform TLS fingerprinting to determine a combination of ciphers returned by TLS handshake. A combination of parameters may also be used to infer the remote device’s operating system or other system features, which may then be used to further classify the entity for selection and refinement of further data protection action(s) to be performed. If the unknown device is a server then access to a server may be blocked—or the server deregistered from the network 102—until the probing indicates that the server does not store data that is classified as sensitive organizational data, or until approval to allow access to the server is received from an authorized administrator 120.

According to various implementations, an unknown device may include an application server 113 in an external network 108. The application server 113 may be hosting SAAS (Software as a Service) services which is being used (e.g., without formal IT authorization or approval) by one or more user endpoint devices 112 or internal servers 110 within the network 102. The security manager server(s) 114 may detect use of the application server 113 by way of reviewing the audit logs of edge devices 106. For example, the audit log of the edge device may indicate that a User X from Device Y accessed Server Z, where Z is some application server 113 outside the network 102. Similarly, other external servers 113 may be detected, such as domain controllers that authenticate users in a data source event.

With regard to a detected applications 113 (FIG. 1) outside the network 102 (e.g., SAAS application 113), the security manager server(s) 114 may determine whether the application is sanctioned or not sanctioned, for example, by performing a lookup of the application in a database of sanctioned applications. In some implementations, if the application is sanctioned (e.g., by being in the database of sanctioned applications) then the security manager server(s) 114 may allow data communications. If the application is not sanctioned then the security manager server(s) 114 may automatically block all access to the application from network 102, for example, by instructing edge device(s) 106 to implement a blocking rule with regard to the application and/or application server hosting the application. In some implementations, the security manager server(s) 114 may block communications, between the application server and other devices on the computer network, that involve data that is classified as sensitive organizational data until the server is identified as a sanctioned server and/or approval to allow access to the server is provided by an authorized administrator 120.

If the unknown device is classified as a server being accessed by a known user base then the security manager server(s) 114 may attempt to determine (e.g., by probing) whether credentials are required to access the server and, if so, whether the credentials are available. Access to the unknown server may be blocked (e.g., by one or more internal edge devices) if the server requires credentials but no credentials are available. In some implementations, the security manager server(s) 114 may identify a user base that accesses the server (e.g., from the audit logs) and/or a supervisor associated with the user base and send a message indicating that use of the server will be blocked until the server is secured and/or the credentials provided. In some implementations, the security manager server(s) 114 may determine no credentials are required to access the server but the server includes sensitive data. In such an example, the security manager may block access to the data (or the server) until the data can be protected by credentials.

Additionally or in the alternative, classification of a device (e.g., user endpoint device 112 or server or SAAS 113) may be based on a type of data transmitted or received by the device or based on a type of data that the device is accessing (e.g., on a server). In such implementations, the security manager server(s) 114 may determine an importance level or a sensitivity level of the data, determine a level of role-based access associated with the importance level or sensitivity level, and then block the device’s access to the network 102 unless the device is authorized with the determined level of role-based access.

FIG. 3 depicts an example process flow diagram for automated discovery and management of unknown devices and assets across an enterprise computer network, according to aspects of the subject technology. For explanatory purposes, the various blocks of example process 300 are described herein with reference to FIGS. 1 and 2, and the components and/or processes described herein. One or more of the blocks of process 300 may be implemented, for example, by one or more servers or computing devices, such as security manager server(s) 114. In some implementations, one or more of the blocks may be implemented apart from other blocks, and by one or more different processors (including virtual processors) or devices. Further for explanatory purposes, the blocks of example process 300 are described as occurring in serial, or linearly. However, multiple blocks of example process 300 may occur in parallel. In addition, the blocks of example process 300 need not be performed in the order shown and/or one or more of the blocks of example process 300 need not be performed.

In the depicted example, known entities monitored in a computer network by a security monitoring system (e.g., security manager server(s) 114) are stored in a monitoring database 118 (302). For the purposes of this disclosure, the known entities may be referred to as a “list” of known entities, but it is understood that the list may include any form of storing the entities in a database or data store. For example, the list may include a plurality of records in any order that can be searched or indexed by a variable. In this regard, a computing device may query the database for a name or other identifier of an entity to determine whether the queried entity is stored in the monitoring database and thus monitored by the security monitoring system. As described previously, the database 118 may be maintained by the security manager server(s) 114, which may include a DSPM or provide DSPM functionality.

Audit logs are obtained indicating entities within the computer network that have initiated access with one or more computing systems that are internal or external to the computer network (304). As described previously, the audit logs of network devices such as edge devices 106 and/or server(s) 110 may be stored in a centralized database 116. In some implementations, this database may be part of a central audit event repository, such as a SIEM. Each server or edge device (e.g., devices 106, 110, or 114) may automatically (e.g., without user involvement) replicate its audit log(s) to the database, or the audit logs may be extracted from a data store associated with each server or edge device by a computing device associated with security manager system 114 and then stored and aggregated into a single database within database 116.

As an example, a first audit log may be created by a first network device and stored in a first audit database associated with the first network device, and a second audit log may be created by a second network device and stored in a second audit database associated with the second network device. The first and second network devices may each be an edge device 106 or a server device 110 (e.g., a file or web server) or, in some implementations, the security manager server(s) 114. In some implementations, the first network device includes a firewall, proxy server, or a network edge device, and the network traffic to the first network devices includes traffic through the first network device; and the second network device is a file server or a web server.

The first and second audit databases may be hosted by databases local to the devices, or hosted by the database server 116, or may be hosted by separate database servers (not shown). Each audit log may, for example, be created based on monitoring network traffic to the respective network device. For example, in the case of an edge device, the network traffic may originate from inside the network 102 from a computer within the network 102, or may originate from outside the network 102 (via network 108) from a device outside the network 102.

In some implementations, an audit log of the first network device identifies the one or more unknown entities as including an external server 113 outside the computer network. That is, the security manager server(s) 114 may identify one or more user endpoint devices that used the first network device to access the external server 113. For example, the audit log of a respective device may indicate that a User X from Device Y accessed Server Z, where Z is either the network device itself or, in the case of an edge device, a node on the network to which traffic passing through the edge device was destined (and transmitted to by the edge device).

In some implementations, the first audit log and the second audit log are extracted (124) from the respective audit databases, for example, by the security manager system 114. The extraction may occur automatically, without user involvement (e.g., according to a predetermined programmed schedule). The extracted data may then be aggregated and stored in a centralized database 116, as shown in FIGS. 1 and 2. In some implementations, each device may periodically replicate (124) its audit log(s) (or a portion thereof) to the centralized database 116, automatically.

The process continues with a determination of whether there are unknown entities in the audit logs that are not in the monitoring database 118. In the depicted example, entities in the audit logs—e.g., now stored in database 116—are compared to entities in the monitoring database 118 (306), and the system determines whether an entity extracted from the audit log(s) is already being monitored by way of identifying a record of its presence in the monitoring database 118, or whether the entity is unknown, and not monitored, by not being present in the monitoring database 118 (308). If the entity is already listed in the database 116 then the entity is already being monitored and can be ignored (310).

After the audit log(s) (e.g., in database 116) are processed, compared, and unknown entities are discovered, each unknown entity is classified (312) and a monitoring record for the entity added to the monitoring database 118 (314). According to various implementations, classifying the entities involves determining a type of the unknown entity, e.g., whether it is a user endpoint device 112, a server 110 (e.g., a file or web server), or an edge device 196. The classification/type of device may be stored in the monitoring record for the device, along with the name and other identifying and/or address information, within the monitoring database 118.

The depicted process completes with the security manager system 114 performing a data protection action based on the classification (316). In this regard, the security manager server(s) 114 may periodically (e.g., at a certain time each night) process the monitoring records currently stored in the monitoring database 118 and, for each record, perform a data protection action.

In some implementations, the security manager server(s) 114 may automatically initiate, based on an unknown entity being added to the monitoring database, an installation of a software package on the user endpoint device the next time the user endpoint device connects to the computer network (if not presently connected). In this regard, each organization may predetermine one or more software packages that are required for a device to be granted rights to communicate on the network 102. The security manager server(s) 114 may, based on address information identified in the monitoring record associated with the endpoint device, initiate a probe to determine whether the predetermined software is installed (or not installed) on the device. The security manager server(s) 114 may then attempt to install the software on the endpoint device. In some implementations, the security manager server(s) 114 may create, on one or more edge devices that are configured to provide access to respective devices, a rule prohibiting the access until the predetermined software is installed on a connecting device. The security manager server(s) may cause a notification (e.g., a push notification) to be displayed on the user endpoint device to inform a user of the device of the rule.

According to various implementations, the type of data protection action performed is based on the type (e.g., classification) of the unknown entity that was discovered in the audit log(s). For example, if the unknown entity is a user endpoint device then the security manager server(s) 114 may automatically initiate an installation of an anti-virus package. Additionally or in the alternative, the security manager server(s) 114 may cause a notification to be provided to the endpoint device, informing a user of the device of the rule requiring installation of the software anti-virus program.

On the other hand, if the unknown entity is classified as a server then the data protection action may include attempting to determine whether sensitive organization data is being transmitted to or stored on the server. The security manager server(s) 114 may initiate, based on the unknown entity being added to the monitoring list, a probe of the server to collect configuration information about the server, and block access to the server until the probe indicates that the server does not store data that is classified as sensitive organizational data, or until approval to allow access to the server is received from an authorized administrator 120. In some implementations, the probe may determine that credentials are required to collect the configuration information. If credentials are not known then the security manager server(s) 114 may identify, from the one or more audit logs, a user base of one or more known users that have accessed the server (e.g., during a predetermined time period). An authorized administrator may then be identified. In some implementations, the administrator may be an information technology administrator for the organization or a department of the organization associated with the users. In some implementations, the administrator(s) may include one or more of the detected users. The security manager server(s) 114 may then notify (e.g., by email or text message) the determined administrator(s) of the access and/or prompt the administrator to supply the credentials. Accordingly, the security manager server(s) 114 may cause access to the server to be blocked until the credentials are received.

Similarly, if the unknown entity includes an external application 113 outside the computer network 102 (e.g., a SAAS) then the security manager server(s) 114 may prompt the administrator 120 to identify whether the application (or server hosting the application) is a sanctioned application (or server); that is, preauthorized by the organization. The security manager server(s) 114 may block communications, between the external application 113 and devices on the network 102, that involve data that is classified as sensitive organizational data, until the application (or server) is identified as being sanctioned and/or approval to allow access to the server is provided by the administrator. As described previously, the security manager server(s) 114 may, identify, from the one or more audit logs, one or more known users that have accessed the server during a predetermined time period; and notify the administrator of the one or more known users that have accessed the server.

In some instances, after determining the type of the one or more unknown entities, the security manager server(s) 114 may notify an administrator that was determined to be associated with the unknown entity and may receive, from the administrative account (after the notifying), an indication to place the respective entity on an ignore list. The security manager server(s) 114 may then ignore the entity (and activities performed by the entity) the next time the entity is discovered in a subsequent audit log.

In some instances, the security manager server(s) 114 may, on identifying an unknown entity, notify an administrator 120 that the respective unknown entity was detected (e.g., initiated access with one or more computing systems in the network), and prompting the administrator 120 to make a decision regarding whether to place the entity in the monitoring list or to select one of multiple protective actions to be performed with respect to the entity. The administrator may provide an indication to place the respective unknown entity on an ignore list. Accordingly, the entity may be identified in a database (e.g., a database separate from the monitoring database) as being an entity that should not be monitored. In some implementations, the entity may be automatically added to the monitoring database 118 and a flag may be set within the database 118 identifying that the entity should not be monitored. When identified as such, the system may ignore the entity when the respective entity is identified in a subsequent audit log during a future processing of audit logs.

Many of the above-described example steps of process 300, and related features and applications, may also be implemented as software processes that are specified as a set of instructions recorded on a computer readable storage medium (also referred to as computer readable medium), and may be executed automatically (e.g., without user intervention). Any or all of the foregoing steps may be performed by a machine, automatically. That is, the step(s) may be performed without user involvement or action, for example, according to a predetermined programmed schedule or in response to a preceding action. When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

The term “software” is meant to include, where appropriate, firmware residing in read-only memory or applications stored in magnetic storage, which can be read into memory for processing by a processor. Also, in some implementations, multiple software aspects of the subject disclosure can be implemented as sub-parts of a larger program while remaining distinct software aspects of the subject disclosure. In some implementations, multiple software aspects can also be implemented as separate programs. Finally, any combination of separate programs that together implement a software aspect described here is within the scope of the subject disclosure. In some implementations, the software programs, when installed to operate on one or more electronic systems, define one or more specific machine implementations that execute and perform the operations of the software programs.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub programs, or portions of code). A computer program can be deployed to be executed on one computer or on multiple computers that are located at one site or distributed across multiple sites and interconnected by a communication network.

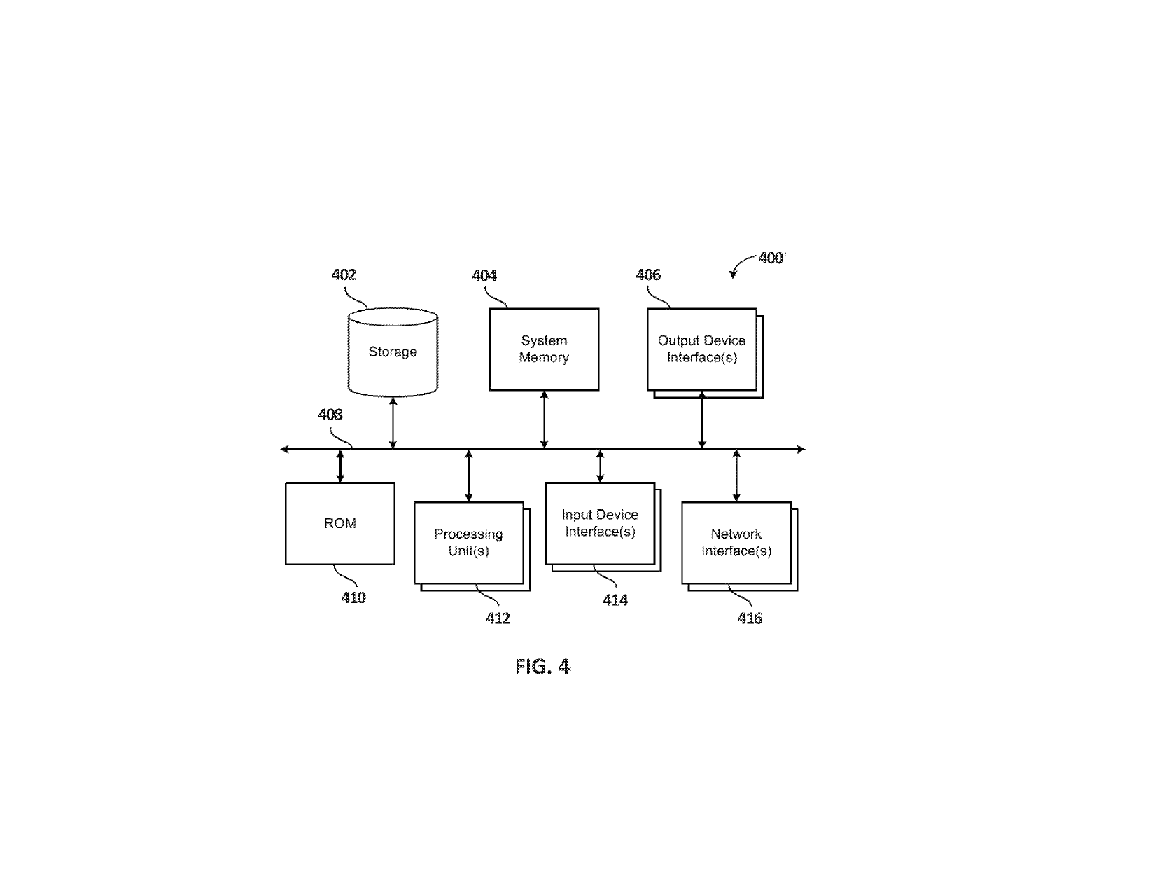

FIG. 4 is a conceptual diagram illustrating an example electronic system for automated discovery and protection of unknown devices and assets across an enterprise computer network, according to aspects of the subject technology. Electronic system 400 may be a specifically configured computing device for execution of software associated with one or more portions or steps of process 400, or components and processes provided by FIGS. 1 through 3, including but not limited to a user endpoint device 112, internal server 110, edge device 106, or external application server 113. Electronic system 400 may be or include a server, a personal computer or a mobile device such as a smartphone, tablet computer, laptop, PDA, an augmented reality device, a wearable such as a watch or band or glasses, or combination thereof, or other touch screen or television with one or more processors embedded therein or coupled thereto, or any other sort of computer-related electronic device having network connectivity.

Electronic system 400 may include various types of computer readable media and interfaces for various other types of computer readable media. In the depicted example, electronic system 400 includes a bus 408, processing unit(s) 412, a system memory 404, a read-only memory (ROM) 410, a permanent storage device 402, an input device interface 414, an output device interface 406, and one or more network interfaces 416. In some implementations, electronic system 400 may include or be integrated with other computing devices or circuitry for operation of the various components and processes previously described.

Bus 408 collectively represents all system, peripheral, and chipset buses that communicatively connect the numerous internal devices of electronic system 400. For instance, bus 408 communicatively connects processing unit(s) 412 with ROM 410, system memory 404, and permanent storage device 402.

From these various memory units, processing unit(s) 412 retrieves instructions to execute and data to process, in order to execute the processes of the subject disclosure. The processing unit(s) can be a single processor or a multi-core processor in different implementations.

ROM 410 stores static data and instructions that are needed by processing unit(s) 412 and other modules of the electronic system. Permanent storage device 402, on the other hand, is a read-and-write memory device. This device is a non-volatile memory unit that stores instructions and data even when electronic system 400 is off. Some implementations of the subject disclosure use a mass-storage device (such as a magnetic or optical disk and its corresponding disk drive) as permanent storage device 402.

Other implementations use a removable storage device (such as a floppy disk, flash drive, and its corresponding disk drive) as permanent storage device 402. Like permanent storage device 402, system memory 404 is a read-and-write memory device. However, unlike storage device 402, system memory 404 is a volatile read-and-write memory, such as a random access memory. System memory 404 stores some of the instructions and data that the processor needs at runtime. In some implementations, the processes of the subject disclosure are stored in system memory 404, permanent storage device 402, and/or ROM 410. From these various memory units, processing unit(s) 412 retrieves instructions to execute and data to process in order to execute the processes of some implementations.

Bus 408 also connects to input and output device interfaces 414 and 406. Input device interface 414 enables the user to communicate information and select commands to the electronic system. Input devices used with input device interface 414 include, e.g., alphanumeric keyboards and pointing devices (also called “cursor control devices”). Output device interfaces 406 enables, e.g., the display of images generated by the electronic system 400. Output devices used with output device interface 406 include, e.g., printers and display devices, such as cathode ray tubes (CRT) or liquid crystal displays (LCD). Some implementations include devices such as a touchscreen that functions as both input and output devices.

Also, as shown in FIG. 4, bus 408 also couples electronic system 400 to a network (not shown) through network interfaces 416. Network interfaces 416 may include, e.g., a wireless access point (e.g., Bluetooth or WiFi) or radio circuitry for connecting to a wireless access point. Network interfaces 416 may also include hardware (e.g., Ethernet hardware) for connecting the computer to a part of a network of computers such as a local area network (“LAN”), a wide area network (“WAN”), wireless LAN, or an Intranet, or a network of networks, such as the Internet. Any or all components of electronic system 400 can be used in conjunction with the subject disclosure.

Each network connections disclosed herein may be a wired or wireless connection, such as by Ethernet, WiFi, BLUETOOTH, an integrated services digital network (ISDN) connection, a digital subscriber line (DSL) modem, or a cable modem. Direct or indirect network connection may be used, including, but not limited to a telephone modem, an MIB system, an RS232 interface, an auxiliary interface, an optical link, an infrared link, a radio frequency link, a microwave link, a personal area network connection, a local area network connection, a cellular link, or a WLANS connection or other wireless connection.

Enterprise devices incorporating aspects of the subject technology may be equipped with a network interface module (NIM), allowing each device to participate as a node in a network. While for purposes of clarity the subject technology will be described as operating in an Ethernet network environment using the Internet Protocol (IP), it is understood that concepts of the subject technology are equally applicable in other network environments, and such environments are intended to be within the scope of the subject technology.

Data to and from the various data sources can be converted into network-compatible data with existing technology, and movement of the information between the appliances and the network can be accomplished by a variety of means. For example, the appliances and network may communicate via automated interaction, manual interaction, or a combination of both automated and manual interaction. Automated interaction may be continuous or intermittent and may occur through direct network connection, or through RS232 links, MIB systems, RF links such as BLUETOOTH, IR links, PANS, LANS, WLANS, digital cable systems, telephone modems or other wired or wireless communication means. The communication means in various aspects may be bidirectional with access to data from as many points of the distributed data sources as possible. Decision-making can occur at a variety of places within the network.

These functions described above can be implemented in computer software, firmware, or hardware. The techniques can be implemented using one or more computer program products. Programmable processors and computers can be included in or packaged as mobile devices. The processes and logic flows can be performed by one or more programmable processors and by one or more programmable logic circuitry. General and special purpose computing devices and storage devices can be interconnected through communication networks.

Some implementations include electronic components, such as microprocessors, storage and memory that store computer program instructions in a machine-readable or computer-readable medium (also referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media can store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some implementations are performed by one or more integrated circuits, such as application specific integrated circuits (ASICs) or field programmable gate arrays (FPGAs). In some implementations, such integrated circuits execute instructions that are stored on the circuit itself.

As used in this specification and any claims of this application, the terms “computer”, “server”, “processor”, and “memory” all refer to specifically configured electronic or other technological devices. These terms exclude people or groups of people. For the purposes of the specification, the terms display or displaying means displaying on an electronic device. As used in this specification and any claims of this application, the terms “computer readable medium” and “computer readable media” are entirely restricted to tangible, physical objects that store information in a form that is readable by a computer. These terms exclude any wireless signals, wired download signals, and any other ephemeral signals.

To provide for interaction with a user, implementations of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; e.g., feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; e.g., by sending web pages to a web browser on a user’s client device in response to requests received from the web browser.

Implementations of the subject matter described in this specification can be implemented in a computing system that includes a back end component, e.g., as a data server, or that includes a middleware component, e.g., an application server, or that includes a front end component, e.g., a client computer having a graphical user interface or a Web browser through which a user can interact with an implementation of the subject matter described in this specification, or any combination of one or more such back end, middleware, or front end components. The components of the system can be interconnected by any form or medium of digital data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and may interact through a communication network. The relationship of client and server arises by virtue of computer programs running on the respective computers and having a client-server relationship to each other. In some implementations, a server transmits data (e.g., an HTML page) to a client device (e.g., for purposes of displaying data to and receiving user input from a user interacting with the client device). Data generated at the client device (e.g., a result of the user interaction) can be received from the client device at the server.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. The described functionality may be implemented in varying ways for each particular application. Various components and blocks may be arranged differently (e.g., arranged in a different order, or partitioned in a different way) all without departing from the scope of the subject technology.

It is understood that the specific order or hierarchy of steps in the processes disclosed is an illustration of example approaches. Based upon design preferences, it is understood that the specific order or hierarchy of steps in the processes may be rearranged. Some of the steps may be performed simultaneously. The accompanying method claims present elements of the various steps in a sample order, and are not meant to be limited to the specific order or hierarchy presented.

### Illustration of Subject Technology as Clauses:

Various examples of aspects of the disclosure are described as numbered clauses (1, 2, 3, etc.) for convenience. These are provided as examples, and do not limit the subject technology. Identifications of the figures and reference numbers are provided below merely as examples and for illustrative purposes, and the clauses are not limited by those identification.

Clause 1. A machine-implemented method comprising: storing, in a monitoring database associated with a security monitoring system, a list of known entities for which a security monitoring system is monitoring via a computer network; automatically obtaining, from one or more audit databases, one or more audit logs indicating entities within the computer network that have initiated access with one or more computing systems that are internal or external to the computer network; automatically determining, from the one or more audit logs, one or more unknown entities that are not in the known entities stored in the monitoring database; and for each determined unknown entity: automatically determining a type of the unknown entity; automatically adding the unknown entity to the monitoring database; automatically selecting a data protection action based on the type of the unknown entity; and automatically facilitating security of network communications pertaining to the unknown entity and the computer network by performing the data protection action.

Clause 2. The machine-implemented method of Clause 1, wherein the data protection action comprises: automatically determining that the unknown entity is a user endpoint device that was connected to the computer network; and automatically initiating, based on the unknown entity being added to the monitoring database, an installation of a software package on the user endpoint device when the user endpoint device connects to the computer network.

Clause 3. The machine-implemented method of Clause 2, wherein the software package comprises an antivirus program.

Clause 4. The machine-implemented method of Clause 1, wherein determining the type of the unknown entity comprises: automatically determining that the unknown entity is a server that was connected to the computer network, and wherein the data protection action comprises: periodically initiating, based on the unknown entity being added to the monitoring list, a probe of the server to collect configuration information about the server; and blocking access to the server until the probe indicates that the server does not store data that is classified as sensitive organizational data, or until approval to allow access to the server is received from an authorized administrator.

Clause 5. The machine-implemented method of Clause 4, determining that credentials are required to collect the configuration information; identifying, from the one or more audit logs, one or more known users that have accessed the server during a predetermined time period; identifying the authorized administrator based on the one or more known users; and requesting the credentials from the authorized administrator, wherein receiving the approval comprises receiving the credentials and the access is blocked until the credentials are received.

Clause 6. The machine-implemented method of Clause 1, wherein determining the type of the unknown entity comprises: automatically determining that the unknown entity comprises an application outside the computer network, and wherein the data protection action comprises: prompting an authorized administer to identify whether the application is a sanctioned application; and blocking communications, between the application and devices on the computer network, that involve data that is classified as sensitive organizational data until the application is identified as a sanctioned application and approval to allow access to the application is provided by an authorized administrator.

Clause 7. The machine-implemented method of Clause 6, further comprising: identifying, from the one or more audit logs, one or more known users that have accessed the application during a predetermined time period; and notifying the authorized administrator of the one or more known users that have accessed the application.

Clause 8. The machine-implemented method of Clause 1, further comprising: extracting, from a first audit database of a first network device connected to the computer network, a first audit log created by the first network device based on network traffic to the first network device; and extracting, from a second audit database of a second network device connected to the computer network, a second audit log created by the second network device based on network traffic to the first network device.

Clause 9. The machine-implemented method of Clause 8, wherein the first network device includes a firewall, proxy server, or a network edge device and the network traffic to the first network devices comprises traffic through the first network device; and the second network device is a file server.

Clause 10. The machine-implemented method of Clause 9, wherein the audit log of the first network device identifies the one or more unknown entities as including an external server outside the computer network, and further identifies one or more user endpoint devices that used the first network device to access the external server.

Clause 11. The machine-implemented method of Clause 1, wherein performing the data protection action comprises: automatically probing each unknown entity via the computer network; collecting, based on the probing, configuration information about each unknown entity, including a network address and software installed on the unknown entity; and storing, in the monitoring database, for each unknown entity, the collected configuration information, in association with an identification of the unknown entity.

Clause 12. The machine-implemented method of Clause 1, further comprising: determining, from the one or more audit logs, a respective unknown entity that is not in the known entities stored in the monitoring database; notifying an administrator associated with the computer network that the respective unknown entity initiated access with the one or more computing systems; receiving, from the administrative account, after the notifying, an indication to place the respective unknown entity on an ignore list; identifying the respective unknown entity in a database as an entity that should not be monitored; and ignoring the respective unknown entity when the respective unknown entity is identified in a subsequent audit log.

Clause 13. The machine-implemented method of Clause 1, further comprising: determining a sensitivity level of data communicated to or from a respective unknown entity of the one or more unknown entities; determining a level of role-based access associated with the sensitivity level; and wherein the data protection action comprises requiring endpoint devices on the computer network to be authorized with the level of role-based access before being able to access the respective unknown entity.

Clause 14. A system, comprising: a server comprising: one or more processors; and a non-transitory memory storing instructions that, when executed by the one or more processors, causes the one or more processors to facilitate performance of the method of any one of Clauses 1-13.

Clause 15. A non-transitory machine readable medium storing instructions thereon that, when executed by a machine, causes the machine to perform the method of any one of Clauses 1-13.

Clause 16. A machine-implemented method comprising: storing, in a monitoring database associated with a security monitoring system, a list of known entities for which a security monitoring system is monitoring via a computer network; automatically obtaining, from one or more audit databases, one or more audit logs indicating entities within the computer network that have initiated access with one or more computing systems that are internal or external to the computer network; automatically determining, from the one or more audit logs, one or more unknown entities that are not in the known entities stored in the monitoring database; and for each determined unknown entity: automatically determining a type of the unknown entity; automatically adding the unknown entity to the monitoring database; automatically selecting a data protection action based on the type of the unknown entity; and automatically facilitating security of network communications pertaining to the unknown entity and the computer network by performing the data protection action, wherein the data protection action includes one or more of: installing a software package on the unknown entity; blocking communications between the unknown entity and devices on the computer network until a predetermined criteria is satisfied; and probing the unknown entity via the computer network to obtain configuration information about the unknown entity.

### Further Considerations:

The previous description is provided to enable any person skilled in the art to practice the various aspects described herein. The previous description provides various examples of the subject technology, and the subject technology is not limited to these examples. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the invention described herein.

The term website, as used herein, may include any aspect of a website, including one or more web pages, one or more servers used to host or store web related content, etc. Accordingly, the term website may be used interchangeably with the terms web page and server. The predicate words “configured to”, “operable to”, and “programmed to” do not imply any particular tangible or intangible modification of a subject, but, rather, are intended to be used interchangeably. For example, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

The term automatic, as used herein, may include performance by a computer or machine without user intervention; for example, by instructions responsive to a predicate action by the computer or machine or other initiation mechanism. The word “example” is used herein to mean “serving as an example or illustration.” Any aspect or design described herein as “example” is not necessarily to be construed as preferred or advantageous over other aspects or designs.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “implementation” does not imply that such implementation is essential to the subject technology or that such implementation applies to all configurations of the subject technology. A disclosure relating to an implementation may apply to all implementations, or one or more implementations. An implementation may provide one or more examples. A phrase such as an “implementation” may refer to one or more implementations and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such as a “configuration” may refer to one or more configurations and vice versa.

What is claimed is:

1. A machine-implemented method, comprising:
storing, in a monitoring database associated with a security monitoring system, a list of known entities for which a security monitoring system is monitoring via a computer network;
automatically obtaining, from one or more audit databases, one or more audit logs indicating entities within the computer network that have initiated access with one or more computing systems that are internal or external to the computer network;
automatically determining, from the one or more audit logs, one or more unknown entities that are not in the known entities stored in the monitoring database; and
for each determined unknown entity:
automatically adding the unknown entity to the monitoring database;
automatically selecting a data protection action for the unknown entity; and
automatically facilitating security of network communications pertaining to the unknown entity and the computer network by performing the data protection action.

2. The machine-implemented method of claim 1, wherein the data protection action comprises:
automatically determining that the unknown entity is a user endpoint device that was connected to the computer network; and
automatically initiating, based on the unknown entity being added to the monitoring database, an installation of a software package on the user endpoint device when the user endpoint device connects to the computer network.

3. The machine-implemented method of claim 2, wherein the software package comprises an antivirus program.

4. The machine-implemented method of claim 1, further comprising:
automatically determining a type of the unknown entity, wherein the data protection action is selected based on the type of the unknown entity,
wherein determining the type of the unknown entity comprises:
automatically determining that the unknown entity is a server that was connected to the computer network, and
wherein the data protection action comprises:
periodically initiating, based on the unknown entity being added to the monitoring list, a probe of the server to collect configuration information about the server; and
blocking access to the server until the probe indicates that the server does not store data that is classified as sensitive organizational data, or until approval to allow access to the server is received from an authorized administrator.

5. The machine-implemented method of claim 4,
determining that credentials are required to collect the configuration information;
identifying, from the one or more audit logs, one or more known users that have accessed the server during a predetermined time period;
identifying the authorized administrator based on the one or more known users; and
requesting the credentials from the authorized administrator,
wherein receiving the approval comprises receiving the credentials and the access is blocked until the credentials are received.

6. The machine-implemented method of claim 1, further comprising:
automatically determining a type of the unknown entity, wherein the data protection action is selected based on the type of the unknown entity,
wherein determining the type of the unknown entity comprises:
automatically determining that the unknown entity comprises an application outside the computer network, and
wherein the data protection action comprises:
prompting an authorized administer to identify whether the application is a sanctioned application; and
blocking communications, between the application and devices on the computer network, that involve data that is classified as sensitive organizational data until the application is identified as a sanctioned application and approval to allow access to the application is provided by an authorized administrator.

7. The machine-implemented method of claim 6, further comprising:
identifying, from the one or more audit logs, one or more known users that have accessed the application during a predetermined time period; and
notifying the authorized administrator of the one or more known users that have accessed the application.

8. The machine-implemented method of claim 1, further comprising:
extracting, from a first audit database of a first network device connected to the computer network, a first audit log created by the first network device based on network traffic to the first network device; and
extracting, from a second audit database of a second network device connected to the computer network, a second audit log created by the second network device based on network traffic to the first network device.

9. The machine-implemented method of claim 8, wherein the first network device includes a firewall, proxy server, or a network edge device and the network traffic to the first network devices comprises traffic through the first network device; and the second network device is a file server.

10. The machine-implemented method of claim 9, wherein the audit log of the first network device identifies the one or more unknown entities as including an external server outside the computer network, and further identifies one or more user endpoint devices that used the first network device to access the external server.

11. The machine-implemented method of claim 1, wherein performing the data protection action comprises:
automatically probing each unknown entity via the computer network;
collecting, based on the probing, configuration information about each unknown entity, including a network address and software installed on the unknown entity; and
storing, in the monitoring database, for each unknown entity, the collected configuration information, in association with an identification of the unknown entity.

12. The machine-implemented method of claim 1, further comprising:
determining, from the one or more audit logs, a respective unknown entity that is not in the known entities stored in the monitoring database;
notifying an administrator associated with the computer network that the respective unknown entity initiated access with the one or more computing systems;
receiving, from the administrative account, after the notifying, an indication to place the respective unknown entity on an ignore list;
identifying the respective unknown entity in a database as an entity that should not be monitored; and
ignoring the respective unknown entity when the respective unknown entity is identified in a subsequent audit log.

13. The machine-implemented method of claim 1, further comprising:
determining a sensitivity level of data communicated to or from a respective unknown entity of the one or more unknown entities;
determining a level of role-based access associated with the sensitivity level; and
wherein the data protection action comprises requiring endpoint devices on the computer network to be authorized with the level of role-based access before being able to access the respective unknown entity.

14. A system, comprising:
a server comprising:
one or more processors; and
a non-transitory memory storing instructions that, when executed by the one or more processors, causes the one or more processors to facilitate performance of the machine-implemented method of claim 1.

15. A non-transitory machine readable medium storing instructions thereon that, when executed by a machine, causes the machine to perform the machine-implemented method of claim 1.
